(19) United States
(12) Patent Application Publication
(10) Pub. No.: US 2025/0258689 A1
(43) Pub. Date: Aug. 14, 2025

(54) MINIMIZING USER TOUCHPOINTS AND DELAYS DURING APPLICATION EXECUTION

(71) Applicant: Altruist Corp., Venice, CA (US)

(72) Inventors: Rachel BROWN, Santa Monica, CA (US); Dmytro LYTVYNENKO, Irvine, CA (US); Brandon ZEEB, Columbus, OH (US); Brandon IRVING, Orlando, FL (US)

(21) Appl. No.: 19/196,664

(22) Filed: May 1, 2025

Related U.S. Application Data
(63) Continuation-in-part of application No. 18/188,673, filed on Mar. 23, 2023.
(60) Provisional application No. 63/649,288, filed on May 17, 2024.
(60) Provisional application No. 63/362,503, filed on Apr. 5, 2022.

(51) Int. Cl. G06F 9/451; G06F 21/64

(52) U.S. Cl. CPC G06F 9/451; G06F 21/64

(57) ABSTRACT

In an embodiment, a system for minimizing user touchpoints and delays during application execution includes a memory having executable instructions and a processor in communication with the memory. The processor is configured to execute the instructions to receive a trigger to execute an application flow including a first system process that operates based on a first user input and a second system process that operates based on a second user input. The second user input is dependent upon an event associated with the first system process. The processor is further configured to execute the instructions to capture the first user input and a seed input related to the second user input, and to dynamically generate the second user input, without interaction with the user, based on a combination of the seed input and dynamic information associated with a detected occurrence of an event during execution of the first system process.

### CROSS-REFERENCE TO RELATED APPLICATIONS

This application is a continuation-in-part of U.S. application Ser. No. 18/188,673 filed Mar. 23, 2023. This application also claims priority to and the benefit of U.S. Provisional Application No. 63/649,288 filed May 17, 2024. The aforementioned applications are incorporated by reference herein in their entirety and are hereby expressly made a part of this specification.

### INTRODUCTION

Software applications often must wait for data to be made available by another application, process, and/or user in order to continue their execution. Sometimes, multiple dependencies can compound to create a longer delay. For example, a software application may need to wait for a user input that is responsive to data not yet produced by another application. In dynamic and interactive environments, the foregoing can occur repeatedly, thus considerably prolonging application execution.

### SUMMARY

In an embodiment, a system for minimizing user touchpoints and delays during application execution includes a memory including executable instructions and a processor in communication with the memory. The processor is configured to execute the instructions to receive a trigger to execute an application flow. The application flow includes a first system process and a second system process, where the first system process operates based on a first user input and the second system process operates based on a second user input. The second user input is dependent upon an event associated with the first system process. The processor is further configured to execute the instructions to capture the first user input and a seed input related to the second user input, and to initiate execution of the first system process using the first user input. The processor is further configured to execute the instructions to detect an occurrence of the event during the execution of the first system process and, responsive to the detection, to dynamically generate the second user input, without interaction with the user, based on a combination of the seed input and dynamic information associated with the detected occurrence of the event.

In an embodiment, a computer-implemented method of minimizing user touchpoints and delays during application execution includes receiving a trigger to execute an application flow. The application flow includes a first system process and a second system process, where the first system process operates based on a first user input and the second system process operates based on a second user input. The second user input is dependent upon an event associated with the first system process. The computer-implemented method further includes capturing the first user input and a seed input related to the second user input, and initiating execution of the first system process using the first user input. The computer-implemented method further includes detecting an occurrence of the event during the execution of the first system process and, responsive to the detection, dynamically generating the second user input, without interaction with the user, based on a combination of the seed input and dynamic information associated with the detected occurrence of the event.

In an embodiment, a computer-program product includes a non-transitory computer-usable medium having computer-readable program cod embodied therein. The computer-readable program code is adapted to be executed to implement a method. The method includes receiving a trigger to execute an application flow. The application flow includes a first system process and a second system process, where the first system process operates based on a first user input and the second system process operates based on a second user input. The second user input is dependent upon an event associated with the first system process. The method further includes capturing the first user input and a seed input related to the second user input, and initiating execution of the first system process using the first user input. The method further includes detecting an occurrence of the event during the execution of the first system process and, responsive to the detection, dynamically generating the second user input, without interaction with the user, based on a combination of the seed input and dynamic information associated with the detected occurrence of the event.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a block diagram illustrating an example system for minimizing user touchpoints and delays during application execution.

FIG. 2 further illustrates certain components of the system illustrated in FIG. 1 in more detail, according to certain embodiments.

FIG. 3 illustrates an example process for minimizing user touchpoints and delays during application execution, according to certain embodiments.

FIG. 4 illustrates an example process for capturing a client approval as a seed input, according to certain embodiments.

FIG. 5 illustrates an example process for dynamically generating a client authorization based on a seed input and dynamic information, according to certain embodiments.

FIG. 6 illustrates an example process for minimizing user touchpoints and delays during application execution, according to certain embodiments.

FIG. 7 illustrates an example computing system, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Application execution often involves a controlled triggering of multiple system processes to achieve a result (e.g., completion of a transaction, fulfillment of a user request, etc.). The system processes may be triggered via, for example, application programming interface (API) calls and, in many cases, may be dependent on each other. For example, one system process may use or consume data that is dynamically generated by another system process, such that data availability is a precondition to execution of that process. Dependencies between system processes can significantly prolong application execution time, for example, since the consuming system process may have its execution delayed by the amount of time it takes the producing system process to dynamically generate and provide the data.

In addition to the above, applications typically have many touchpoints with users over the course of their execution. Each touchpoint can take the form of a user flow in which one or more user interfaces are provided to obtain, for example, data to be processed, an authorization of an action to be performed, and so forth. Different system processes may operate on different sets of user input. Moreover, some system processes may operate based on user input that is specific, or responsive, to data that is dynamically produced by another process. These user inputs typically result in additional user touchpoints during execution and, furthermore, typically serve as additional preconditions to execution. Accordingly, the resultant user touchpoints can delay execution by the amount of time it takes a user to execute user flows for each such user input. This delay often compounds with the delay due to process interdependencies discussed above.

User touchpoints, therefore, present technical hurdles in application execution, particularly when they occur in combination with dependencies between system processes. In general, each additional user touchpoint interrupts otherwise continuous execution of the application with a delay of indeterminate length, as it is not always clear when user input will be provided. These delays make the application appear generally slower and less responsive as measured, for example, by application execution time, end-to-end response time, and/or other via other metrics.

For example, and not by way of limitation, in certain embodiments described herein, a computing environment (or platform), such as a cloud computing environment, provides software applications and/or computing services that enable registered investment advisors (sometimes referred to as financial advisors) to interact with clients in order to provide financial services to the clients. The example cloud computing environment may allow users (e.g., registered investment advisors, clients, auditing personnel, etc.) access to both online services and local client applications, regardless of whether the application is installed locally by a user or accessed as an online service (e.g., via an e-commerce/brokerage website). Once client data is stored by the cloud computing environment, users can access data using a variety of clients, including a web browser used to access a software application as a series of web pages, dedicated “thin” client applications, and so-called “apps” accessed using a mobile telephone or computing tablet.

As part of the computing services, the example cloud computing environment may allow registered investment advisors to set up different types of brokerage accounts (e.g., individual accounts, trust accounts, joint accounts, individual retirement account (IRA), Roth IRAs, simplified employee pension plan (SEP) IRAs, etc.), connect bank accounts to brokerage accounts, build custom model portfolios, trade shares, trade fractional shares, generate and share performance reports, and perform other types of transactions. The cloud computing environment may also enable registered investment advisors to initiate account transfers between a client's accounts in order to move funds as part of managing the client's finances.

According to the above example, various application flows may be executed by the example cloud computing environment. An onboarding application flow, for example, may be used to set up one or more clients in the computing environment. The onboarding application flow can include, for example, obtaining user input data for opening accounts, adding beneficiaries, adding bank accounts, and approving various types of authorizations. Account information can include, for example, an account owner name, financial institution name, account type, and an account number, etc.

With respect to approving authorizations, generally, a client has to grant authorization to a registered investment advisor before the registered investment advisor can initiate an account transfer on behalf of the client. This authorization is typically in the form of a letter of authorization (LOA), which, for example, may indicate the bank accounts that the registered investment advisor is authorized to access, the type of transfers for the brokerage accounts that the registered investment advisor is allowed to initiate, the type of transfers for the bank accounts that the registered investment advisor is allowed to initiate, etc. More particularly, in many cases, this authorization may refer to dynamic information associated with events that occur during other system processes. For example, the authorization may refer to an account number that is generated, or becomes available, as part of a system process for opening a corresponding account. Accordingly, the authorization may be considered to be dependent on dynamic information associated with opening of the account, and hence, dependent on an event of account opening (sometimes referred to herein as an “account-open event”).

Therefore, according to the above example, a typical onboarding application flow can include, for example: (a) an advisor portion in which the registered investment advisor configures or administers actions to be executed for a client, for example, by selecting accounts for management; (b) a client portion where the client provides information, for example, to set up or create accounts; (c) execution of system processes to onboard the client, including opening accounts and/or handling follow-up; and (d) additional advisor and/or client portions that are executed responsive to events that occur during the system processes, such as user flows to coordinate the client's authorization for the registered investment advisor to act relative to newly opened accounts (e.g., initiate account transfers and/or move funds). Each interaction with the advisor and/or client may be considered a user touchpoint that delays application execution in the manner discussed previously.

Furthermore, continuing the above example, substantial time can pass between user touchpoints. For instance, know-your-customer (KYC) checks and/or other system prerequisites can cause the system process for account opening to take a substantial period of time (e.g., several days). In general, the time to complete an account opening directly translates into a corresponding delay between user touchpoints (e.g., the time between (b) and (d) above). As the time between user touchpoints increases, the client's responsiveness often decreases, thus further delaying application execution.

The present disclosure describes examples of minimizing user touchpoints and corresponding application execution delays when executing an application flow. The application flow can include, for example, controlled execution of multiple system processes that each operate based on different user input. Some of the system processes may operate based on user input that is dependent on (e.g., responsive to) events and dynamic information associated with other system processes.

In certain embodiments, an example system described herein can capture, in a user flow, user input to be operated on by one or more of the system processes. Additionally, in the same user flow, the system can capture seed input(s) related to other user input that is dependent upon dynamic information not yet available. In certain aspects, when the dynamic information later becomes available, for example, due to the occurrence of an event during the execution of the other system process, the system can dynamically generate the other user input based on a combination of the seed input and the dynamic information. Advantageously, in certain embodiments, the dynamic generation of the other user input can be performed by the system without further interaction with the user. In this way, the system can initiate execution of the system process or processes that operate based on that dynamically generated user input without introducing further execution delay due to a need to execute additional user flows to capture the other user input.

Although examples are periodically provided herein relative to an onboarding flow involving a registered investment advisor and a client, it should be appreciated that the principles described herein are similarly applicable to other types of users and other types of application flows involving interdependent system processes and/or user inputs.

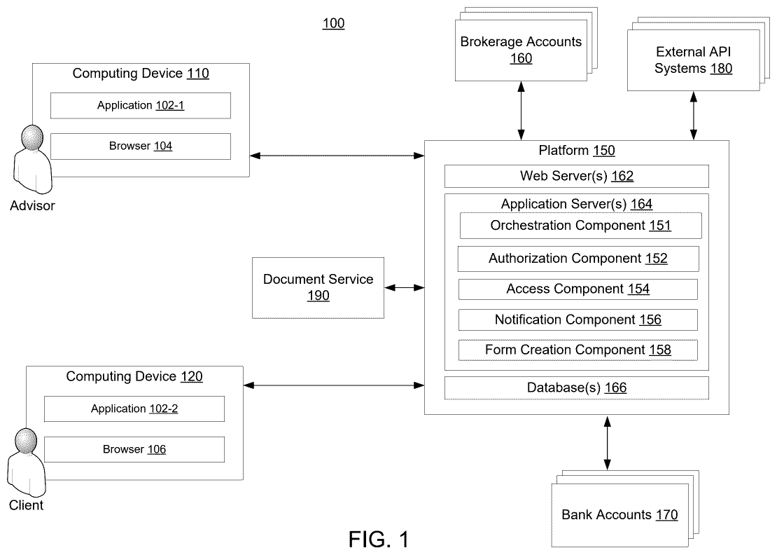

FIG. 1 is a block diagram illustrating an example system 100 for minimizing user touchpoints and delays during application execution, according to certain embodiments. Generally, FIG. 1 and the following description are intended to provide a brief, general description of a suitable computing environment in which the embodiments described herein may be implemented. As shown, FIG. 1 includes a platform 150 (also referred to herein as a cloud computing platform, computing platform, or cloud computing environment), a computing device 110, a computing device 120, external API systems 180, a document service 190, brokerage accounts 160, and bank accounts 170. Note that while a single computing device 110 and a single computing device 120 are depicted, in certain embodiments, the system 100 may include any number of computing devices 110 and any number of computing devices 120.

The platform 150 may include a number of application servers 164 that provide various online web and application services to the computing devices 110 and 120 over a network. A user (e.g., registered investment advisor) may use the computing device 110 to interact with the platform 150. Similarly, a user (e.g., client) may use the computing device 120 to interact with the platform 150. Computing devices 110 and 120 are representative of a variety of computing devices, including, for example, a personal computer, a desktop workstation, a laptop, a tablet computer, a notebook, a personal digital assistant (PDA), an electronic book reader, a game console, smart television, a set-top box, a consumer electronics device, a server computer, or any other computing device capable of communicating with the platform 150 across a network (e.g., local area network (LAN), wireless LAN, personal area network (PAN), a cellular network, wide area network (WAN), Internet, combinations thereof, etc.).

The computing devices 110 and 120 are generally configured to host applications used to access and utilize the web and application services provided by the platform 150. For example, computing device 110 includes an application 102-1 and/or a (web) browser 104. Similarly, computing device 120 includes an application 102-2 and/or a browser 106. The browsers 104, 106 can be used to access the platform 150 by rendering web pages received from the platform 150. The application 102 is representative of a component of a client server application (or other distributed application) which can communicate with the platform 150 over a network. Application 102 may be a “thin” client where the processing is largely directed by the application 102, but performed by computing systems of the platform 150 or may be a conventional software application installed on the computing devices 110 and 120.

The application 102 and/or browsers 104 and 106 are configured to communicate with the platform 150. In certain embodiments, the application 102 and/or browsers 104 and 106 can exchange data with application server(s) in the platform 150 using the hypertext transfer protocol (“HTTP”) over a network. In general, the application 102 and/or browsers 104 and 106 can utilize any number of communication methods known in the art to communicate with the application server(s) in the platform 150, including remote procedure calls, API calls, Simple Object Access Protocol (SOAP)-based web services, remote file access, proprietary client-server architectures, and the like.

In the case where the platform 150 provides financial management services, the application 102 and/or browsers 104 and 106 may provide software which allows a user (e.g., registered investment advisor) to manage one or more brokerage accounts on behalf of another user (e.g., client). The platform 150 may also provide other features, such as the ability to set up different types of brokerage accounts, connect bank accounts to the brokerage accounts, build custom model portfolios, trade shares, trade fractional shares, generate and share performance reports, etc.

As shown, the platform 150 includes a web server(s) 162, an application server(s) 164, and a database(s) 166. In the depicted embodiment, the platform 150 is modeled as a service back-end (e.g., web server(s), application server(s), database(s), etc.). Of course, other software architectures or distributed application frameworks could be used. The web server(s) 162 and application server(s) 164 may be representative of physical computing systems, as well as representative of virtual machine instances deployed to a computing cloud environment. Similarly, the database(s) 166 can be located on a single computing system or distributed across multiple computing systems. The web server(s) 162 may communicate with the application server(s) 164 to respond to requests from applications (e.g., application 102) and/or browsers (e.g., browsers 104, 106) on the computing devices 110 and 120. The web server(s) 162 and/or application server(s) 164 may retrieve application content from the database(s) 166 to respond to requests from the applications and/or browsers on the computing devices 110 and 120, and/or store application content into the database(s) 166.

The application server(s) 164 may execute a number of components (also referred to as modules) to provide web-based and other content to the computing devices 110 and 120. The components may execute on a single application server 164 or in parallel across multiple application servers in the platform 150. In addition, each component may consist of a number of subcomponents executing on different application servers 164 or other computing devices in the platform 150. The components may be implemented as software, hardware, or any combination thereof. In certain embodiments, the application server(s) 164 include an orchestration component 151, an authorization component 152, an access component 154, a notification component 156, and a form creation component 158, each of which is described in more detail below.

In certain embodiments, the application server(s) 164 include application content (e.g., graphical user interface (GUI) components) that platform 150 can present on computing devices 110, 120, based on a user's (e.g., registered investment advisor, client, etc.) interaction with the platform 150. The application content can include, for example, HyperText Markup Language (HTML) components or code that generates HTML components that can be passed to computing devices 110, 120 and rendered as a user interface. The application content may additionally include instructions executable by computing devices 110, 120 to display a user interface using language-specific or operating systems-specific application content (e.g., instructions for generating/displaying JavaScript based components or similar components on other operating system platforms, Abstract Window Toolkit or Swing API components on the Java platform, and so on). Generally, instructions capable of rendering application content on computing devices 110, 120 may include computer executable code generated from compiling and/or interpreting C (or variants thereof), Java, PHP, Ruby, HTML, JavaScript, Python, AJAX, VBscript, and other programming or scripting languages used to compose and present application content.

The brokerage accounts 160 are representative of different types of brokerage accounts, including, for example, individual accounts, trust accounts, joint accounts, IRAs, Roth IRAs, SEP IRAs, etc. The bank accounts 170 can include individual accounts, joint accounts, etc. The document service 190 is generally representative of a document management system (DMS). For example, the document service 190 can receive, track, manage, and store documents (including LOA forms). In certain embodiments, the document service 190 can keep track of different versions of digital forms that have been generated and modified by different users over time. The document service 190 may be implemented on one or more computing systems, which may be located within a cloud environment.

In certain embodiments, information associated with the brokerage accounts 160, bank accounts 170, and/or document service 190 may be located on computing systems external to the platform 150. For example, such external computing systems may include applications and/or databases that host this information. In such embodiments, the external API system(s) 180 generally allow the platform 150 to interact with these external computing systems. For example, the external API system(s) 180 can provide a data transfer network/infrastructure that allows applications provided by the platform 150 to access applications and/or databases within the external computing systems with a set of custom APIs. As a reference example, assuming information associated with a client's bank account is located on an external computing system, the platform 150 can use the external API system to connect to the external computing system (e.g., hosting information associated with the client's bank account 170) in order to initiate an account transfer (e.g., withdrawal, deposit, etc.), check a balance, make a payment, etc. Examples of external API system(s) 180 include, but are not limited to, Plaid®, Stripe Connect®, MX®, Codat®, Yodlee®, etc.

Note that while the brokerage accounts 160, bank accounts 170, and/or document service 190 are shown external to the platform 150, in certain embodiments, the information associated with brokerage accounts 160, bank accounts 170, and/or document service 190 may be located on one or more computing system(s) within the platform 150. For example, information associated with one or more of the brokerage accounts 160 and/or one or more of the bank account(s) 170 may be hosted (or maintained) within one of the database(s) 166.

The authorization component 152 is generally configured to generate a digital LOA containing permissions that authorize a registered investment advisor to perform certain actions such as, for example, moving funds on behalf of a client. The authorization component 152 may receive a request from the computing device 110 (associated with the registered investment advisor) that requests the authorization component 152 to generate the digital LOA. In certain embodiments, the request is in the form of an API call. The API call may include parameters indicating at least one of: an indication of the brokerage account(s) associated with the digital LOA, a type of the brokerage account(s), an indication of the bank account(s) associated with the digital LOA, a type of the bank account(s), a type of transfer to authorize for the bank account(s), an indication of the bank account owners (or account holders), etc.

In certain embodiments, in response to receiving the request, the authorization component 152 can use an external API system(s) 180 to connect with (or access) the indicated bank account(s) 170 and retrieve information (e.g., account number(s), routing number(s), account holder information, etc.) associated with the indicated bank account(s). Note, however, that in certain embodiments, the authorization component 152 may retrieve the information from another storage system (e.g., database(s) 166).

The authorization component 152 can obtain a digital LOA form (e.g., from database(s) 166) and trigger the form creation component 158 to auto-populate the digital LOA with the applicable information obtained from at least one of the request from the computing device 110, the bank account(s) 170, the database(s) 166, etc. For example, the digital LOA form may include one or more blank fields for account number, bank name, routing number, account holder name, etc. The form creation component 158 can execute an automated script to read data from the digital LOA, detect the form fields, and input data in order to fill out the form fields.

The notification component 156 is generally configured to communicate with computing devices 110, 120 and other computing systems in the network. For example, as described below, the notification component 156 can send requests to approve a digital LOA to one or more computing devices 120 associated with clients that are account holder(s) of the bank account(s) within the LOA. Similarly, the notification component 156 can generate and transmit alerts to relevant computing devices in response to various events, including, for example, account-open events, revocation of standing LOAs, denial of pending LOAs, acceptance of pending LOAs, LOA renewal requests, initiated account transfer, completed account transfer, etc.

The access component 154 is generally configured to interact with bank account(s) 170 and/or brokerage account(s) 160, based on the permissions within a standing LOA. For example, in response to a request from a computing device 110 to initiate an account transfer using a standing LOA, the access component 154 can connect to the relevant bank account 170 via the external API system(s) 180 to execute the account transfer (e.g., withdrawal, deposit, etc.). In another example, the access component 154 can initiate internal transfers between brokerage accounts 160 associated with a client, using a standing LOA. In yet another example, the access component 154 can connect to a bank account 170 via an external API system(s) 180 to initiate a wire transfer.

The orchestration component 151 is generally configured to execute an example client onboarding application flow, for example, using the authorization component 152, the access component 154, the notification component 156, and/or the form creation component 158. In certain embodiments, the client onboarding application flow specifies a sequence of system actions for setting up one or more clients to receive financial services from a registered investment advisor. The client onboarding application flow can include, for example, one or more user flows that capture user input, for example, from the client and/or the registered investment advisor, and one or more system processes that operate based on the user input.

In certain embodiments, the orchestration component 151 is configured to execute the client onboarding application flow in a way that minimizes user touchpoints and delays. In certain embodiments, some of the fields of the digital LOA form used by the authorization component 152 may relate to dynamic information that is not available at a time of an initial touchpoint with the client. For example, an account number, a date of account opening, and/or other dynamic information may not be available until a corresponding account is open. Accordingly, in the example of FIG. 1, a client authorization, such as an approved or signed digital LOA, may not be ripe for capture at the time of the initial touchpoint with the client, and the client authorization may thus be considered to be dependent on an account-open event for the corresponding account. As discussed previously, the dynamic information for the account may not be available for a substantial period of time (e.g., several days), for example, due to KYC checks and/or other prerequisites.

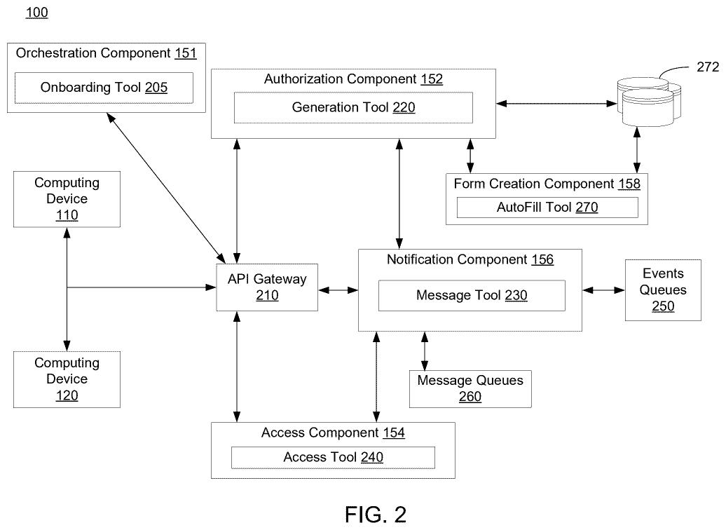

In various embodiments, the orchestration component 151 can capture, at the time of the initial touchpoint with the client, a seed input related to the client authorization. The seed input can be, for example, a client approval to automatically generate and sign the client authorization (e.g., the digital LOA), at a later time, in response to an occurrence of the account-open event. In this way, the seed input serves as a general approval that the orchestration component 151 can map or apply to the account, although the seed input lacks specificity with regard to an account number and/or other dynamic information, as may be required for the client authorization (e.g., the signed LOA). The client approval can include, for example, an approval to populate an electronic form with dynamic information associated with the account, and to insert a signature associated with the client. In some cases, the signature can be included in, or captured with, the client input. Examples of capturing and using seed input will be described in greater detail relative to FIGS. 2-6.

FIG. 2 further illustrates components of the system 100, described relative to FIG. 1, according to certain embodiments. As noted, the platform 150 is generally responsible for implementing the back-end processes that enable a user (e.g., registered investment advisor, client, etc.) to access the computing services provided by the platform 150, via applications (e.g., application 102) and/or browsers (e.g., browsers 104, 106). In certain embodiments, the platform 150 can be based on a micro-services architecture. In certain embodiments, the platform 150 is implemented using one or more cloud computing services.

As shown in FIG. 2, the platform 150 includes an API Gateway 210, event queues 250, message queues 260, and databases 272. Note that the number of components depicted in FIG. 2 is a reference example and that the platform 150 can include any number of components (e.g., API Gateways, message queues, event queues, etc.). The API Gateway 210 receives and forwards requests from the applications 102-1 and 102-2 and/or browsers 104, 106 of the computing devices 110 and 120. Additionally, the API Gateway 210 may receive and forward responses from one or more components (e.g., authorization component 152, form creation component 158, notification component 156, access component 154, etc.) to the application and/or browsers of the computing devices 110 and 120.

In certain embodiments, the API Gateway 210 employs a request/response model. In such embodiments, API requests may be sent to the API Gateway 210 using Representational State Transfer (REST) API methods. For example, the API requests can include API methods, such as GET, POST, PUT, etc. In certain embodiments, the API Gateway 210 employs a bi-directional, full-duplex communication model. In such embodiments, the API Gateway 210 can use websocket APIs to allow computing devices and components to send messages independently. That is, the communication may not require a new connection to be set up for each message sent between clients and services. Once the connection is set up, messages can be sent and received continuously without interruption.

As shown, the orchestration component 151 includes an onboarding tool 205. The onboarding tool 205 is generally configured to execute the client onboarding application flow discussed relative to FIG. 1. In general, the onboarding tool 205 is configured to control or trigger operation of the other components shown in FIG. 2, including the authorization component 152, the access component 154, the notification component 156, and the form creation component 158. Each of these components is further discussed below.

As shown, the authorization component 152 includes a generation tool 220, which is generally configured to generate a digital LOA form. The generation tool 220 may obtain (or retrieve) the applicable LOA form from the database(s) 272, which can store different types of LOA forms. The different types of LOA forms may be associated with at least one of different geographical jurisdictions (e.g., different states may have different legal standards for LOA forms), different types of transfers (e.g., ACH transfers, wire transfers, etc.), different types of brokerage accounts, etc. In certain embodiments, upon receiving an API request to generate a digital LOA from the computing device 110 via the API gateway 210, the generation tool 220 can determine the type of LOA form to retrieve from the database(s) 272, based one or more attributes of the API request. These attributes can include, but are not limited to, brokerage account identifier, bank account identifier, type of brokerage account, type of bank account, type of transfer, number of account holders, etc.

The generation tool 220 can trigger the form creation component 158 to auto populate one or more fields of the digital LOA form retrieved from the database(s) 272. In certain embodiments, the form creation component 158 includes an autofill tool 270, which can detect form fields in the digital LOA, and populate the form fields with information obtained from the API request and/or storage systems (e.g., database(s) 272, external API systems 180, bank accounts 170, brokerage accounts 160, etc.).

Each form field may include a token (or keyword) (in ASCII format, for example) that indicates the type of information that belongs in the form field. For example, a digital LOA form may have a first form field with “advisor_name,” a second form field with “bank account1_name,” a third form field with “bank_account1_number,” a fourth form field with “bank account1_accountholder,” a fifth form field with “bank account2_name,” a sixth form field with “bank account2_number,” a seventh form field with “bank account2_accountholder,” and so on. The autofill tool 270 can determine the type of data and data format for each form field in the digital LOA form from the token (or keyword) in the form field. The autofill tool 270 can then modify each of the form fields with the corresponding data. In certain embodiments, the data for the form field may be extracted from the API request and/or storage systems. The autofill tool 270 can save the filled digital LOA form in one or more different file formats, including, for example, portable document format (PDF), .doc, HTML, etc., and store the filled digital LOA in a storage system (e.g., database(s) 166, document service 190, etc.).

As shown, the access component 154 includes an access tool 240, which can interact with external bank accounts (e.g., bank accounts 170) to perform account transfers (e.g., deposits, withdrawals, etc.). The access component 154 can send API calls to external API systems 180 in order to connect to and access the external systems (e.g., bank accounts) to perform the account transfer.

As shown, the notification component 156 includes a message tool 230, which is generally configured to handle messages between the platform 150 and the computing devices 110 and 120. In certain embodiments, the message tool 230 subscribes to one or more event queues 250 and/or one or more message queues 260. The platform 150 may post messages to particular queues (e.g., event queues 250 and/or message queues 260), based on actions performed one or more components within the platform 150. For example, when the form creation component 158 creates and autofills a digital LOA form, it may post a message to an event queue 250. This message within the event queue 250 may trigger the notification component 156 to generate a request for a user to approve the digital LOA form (e.g., “LOA Approval Request”). In another example, when the access component 154 completes an account transfer with a bank account 170, the access component 154 may post a message to an event queue 250 that triggers the notification component 156 to generate a message with an indication of the completed account transfer.

The message tool 230 may post messages to send to the computing devices 110 and 120 to a message queue 260. These messages, for example, can include a request for a user to approve a digital LOA form, a message indicating approval of a digital LOA form, a message indicating denial of a digital LOA form, a message indicating a completed account transfer, etc. A computing function associated with the message queue 260 can call the API gateway 210 in order to send the message(s) to the computing device 110 and/or computing device 120. In certain embodiments, the event queues 250 and/or message queue(s) 260 may be implemented using a cloud computing message queuing service, such as Amazon Simple Queue Service (SQS).

In certain embodiments, one or more components of the platform 150 may include an event-driven computing engine (also referred to as an event-driven computing service) that performs operations of the respective component(s). An event-driven computing engine can invoke (or execute) predefined functions in response to some triggering event. The event-driven computing engine can provide a serverless compute service that runs application code (e.g., functions) in response to events and automatically manages underlying compute resources used to execute the application code. One example of an event-driven computing engine is Amazon Lambda.

As a reference example, in certain embodiments, the authorization component 152 and/or the form creation component 158 may perform actions using predefined functions executed (or invoked) by an event-driven computing engine, such as Lambda. In these embodiments, a LOA generation request may be placed in an event queue 250, for example, when an API request (“Create LOA Request”) is received. This LOA generation request may be the triggering event that prompts the generation tool 220 to obtain the digital LOA form from the database(s) 272, e.g., using predefined functions executed as part of an event-driven computing engine. The retrieval of the digital LOA form from the database(s) 272 may serve as another triggering event that prompts the form creation component 158 to execute predefined functions (as part of an event-driven computing engine) in order to auto-populate the one or more fields of the digital LOA form.

In this manner, certain embodiments can leverage event queues (e.g., SQS queues) and event-driven computing engines to handle multiple LOA generation requests.

Note that FIG. 2 depicts a reference example of components that can be used to implement the generation of a digital LOA and is not intended as the sole implementation, as other components/architectures for generating a digital LOA can be used.

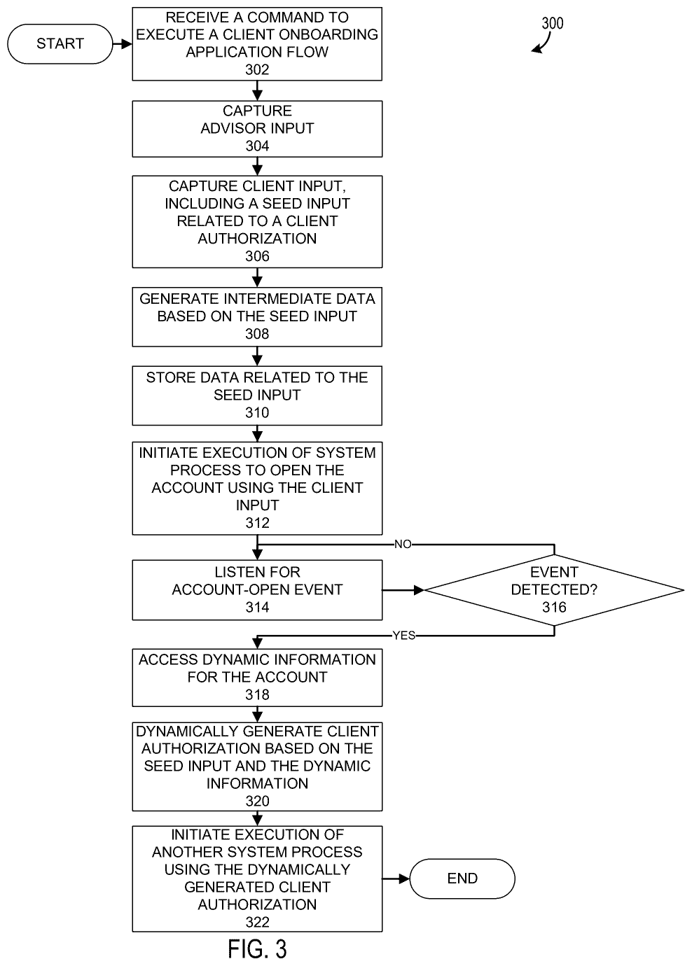

FIG. 3 illustrates an example process 300 for minimizing user touchpoints and delays during application execution, according to certain embodiments. For illustrative purposes, the process 300 is described relative to a client onboarding application flow involving a registered investment advisor and a client. Although any number of systems, in whole or in part, can implement the process 300, to simplify discussion, the process 300 will be described in relation to the platform 150 of FIGS. 1-2.

At block 302, the platform 150 receives a command to execute a client onboarding application flow. The command can be, for example, a client onboarding request that is received from the registered investment advisor via the computing device 110. In certain embodiments, the client onboarding application flow specifies a sequence of system actions for setting up one or more clients to receive financial services from a registered investment advisor, as discussed relative to FIGS. 1-2. The client onboarding application flow can include, for example, one or more user flows that capture user input and one or more system processes that operate based on the user input. Although multiple clients can be accommodated in the client onboarding application flow, for simplicity of description, the process 300 will be described relative to a single client, with the understanding that the same or similar actions can be executed in parallel for each such client.

At block 304, the platform 150 captures advisor input from the registered investment advisor. In general, the capture at the block 304 corresponds to an advisor portion of the client onboarding application flow. The block 304 can include, for example, the platform 150 executing a user flow with the registered investment advisor to capture the advisor input. The block 304 can include, for example, the platform 150 receiving data related to one or more clients to be served by the registered investment advisor.

For example, as part of capturing the advisor input at the block 304, the platform 150 can receive, from the computing device 110, an indication of one or more of the following for the client: the brokerage account(s) 160, bank account(s) 170, type of transfer, etc. In addition, or alternatively, the registered investment advisor may use the computing device 110 to indicate one or more data elements for client entry during a client portion of the application flow, such as user input for opening accounts, adding beneficiaries, adding bank accounts, and approving various types of authorizations.

At block 306, the platform 150 captures client input that includes a seed input, as further discussed below. In general, the capture at the block 306 corresponds to a client portion of the client onboarding application flow. The block 306 can include, for example, the platform 150 executing a user flow with the client to capture the client input. For example, as part of capturing the client input at the block 306, the platform 150 can receive, from the computing device 120, account information, beneficiary information, and/or various types of approvals or authorizations. For a given account, the account information can include, for example, an account owner name, a financial institution name, an account type, an account number, etc.

In certain aspects, the seed input, which is included in the captured client input, relates to another client input that cannot be directly obtained at the time of executing the block 306. In the example of FIG. 3, the other client input is a client authorization for the registered investment advisor to access, and/or act relative to, an account, such as a bank account, that is not yet open. The client authorization may be, for example, a signed LOA as discussed previously.

In the example of FIG. 3, the client authorization may not be ripe for capture at the time of executing the block 306, for example, because it references dynamic information for the account that is not available at the time of executing the block 306. The dynamic information can include information that is typically available upon opening of the account, such as an account number, a date of account opening, etc. Therefore, in the example of FIG. 3, the client authorization may considered to be dependent on an event of account opening. As discussed previously, the dynamic information for the account may not be available for a substantial period of time (e.g., several days), for example, due to KYC checks and/or other account-opening prerequisites.

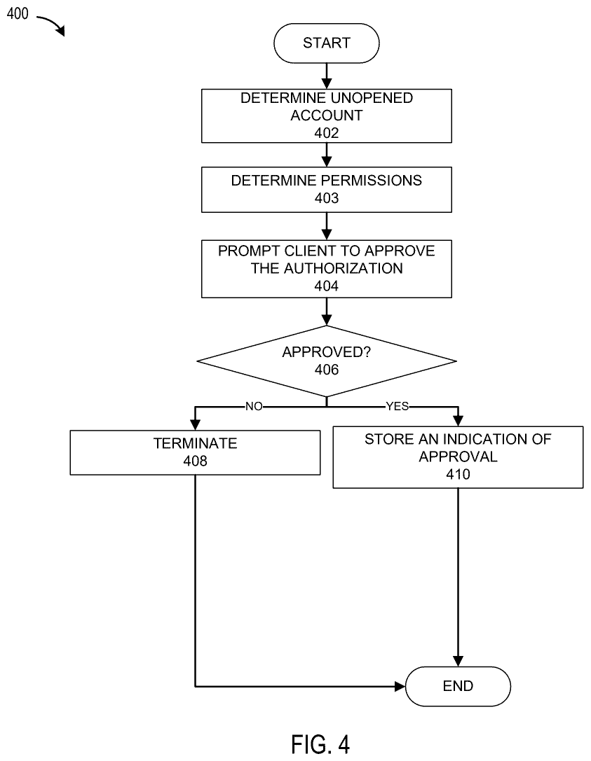

In the example of FIG. 3, the seed input can be a client approval to automatically generate the client authorization (e.g., the signed LOA), at a later time, in response to a later occurrence of the account-open event. In this way, the seed input serves as a general approval that can be mapped to the account by the platform 150, although the seed input lacks specificity with regard to an account number and/or other dynamic information, as may be required for the client authorization (e.g., the signed LOA). The client approval can include, for example, an approval to populate an electronic form with dynamic information associated with the account, and to insert a signature associated with the client. In some cases, the signature can be included in, or captured with, the client input. An example of capturing the seed input will be described relative to FIG. 4.

At block 308, the platform 150 generates intermediate data based on the seed input. In general, the block 308 can include generating data objects based on the client input. In some aspects, the data objects can correspond to a structure of data for the client authorization, so as to facilitate generation of the client authorization upon the occurrence of the account-open event. In certain embodiments, the block 308 can be omitted, for example, in favor formatting and arranging data at the time of generating the client authorization.

At block 310, the platform 150 stores data related to the seed input, for example, in the database(s) 272. For example, in some embodiments, the platform 150 can store the seed input, the intermediate data, if any, generated at the block 308, the client input, and/or other data.

At block 312, the platform 150 initiates execution of a system process to open the account using at least some of the client input. In some embodiments, the platform 150 can initiate the system process to open the account via, for example, an API call to another component. The other component can be internal to the platform 150, external to the platform 150 (e.g., corresponding to an application service provider or a financial institution), and/or the like.

At block 314, the platform 150 listens for the account-open event. In various embodiments, the account-open event can be indicated, for example, by alert, notification, API call, and/or the like. At decision block 316, the platform 150 determines whether the account-open event has been detected. If the account-open event has not been detected, the process 300 returns to the block 314, where the platform 150 continues to listen for the account-open event. Otherwise, if the account-open event is detected, the process 300 proceeds to block 318.

At block 318, the platform 150 accesses dynamic information for the account. The dynamic information can include, for example, an account number, a date of account opening, an opening balance, and/or the like. In some cases, some or all of the dynamic information can be accessed from a data store and/or via an API call. In addition, alternatively, some or all of the dynamic information can be provided along with, for example, an alert or notification associated with the account-open event.

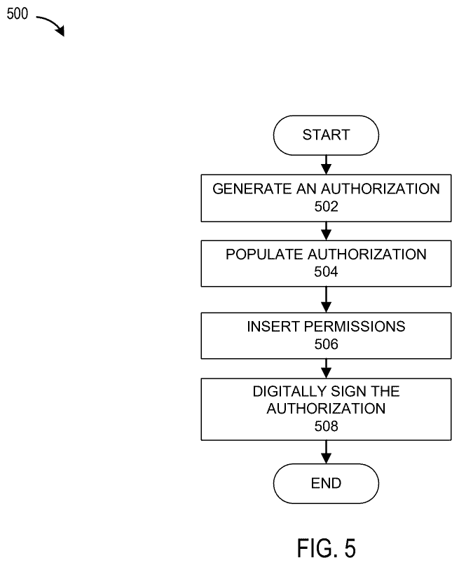

At block 320, the platform 150 dynamically generates the client authorization without interaction with the client. For example, the platform 150 can automatically populate an electronic form and cause the electronic form to be digitally signed using a digital signature associated with the client. In certain embodiments, the platform 150 can populate the electronic form with various portions of the client input and/or the intermediate data. In particular, the platform 150 can populate the electronic information with at least some of the dynamic information accessed at the block 318, such as the account number. An example of dynamically generating the client authorization will be described relative to FIG. 5.

At block 322, the platform 150 initiates execution of another system process using the client authorization dynamically generated at the block 320. In some embodiments, the system process can be a process to provide the client authorization to a financial institution, clearing house, or other entity. In addition, or alternatively, the other system process can be a process that takes action according to the client authorization, such as action to execute an account transfer or move funds. In some embodiments, the platform 150 can initiate the other system process via, for example, an API call to another component. After block 322, the process 300 ends.

FIG. 4 illustrates an example process 400 for capturing a client approval as a seed input, according to certain embodiments. For illustrative purposes, the process 400 is described relative to a client onboarding application flow involving a registered investment advisor and a client. In various embodiments, the process 400 can be, performed, for example, as part of the block 306 of FIG. 3. Although any number of systems, in whole or in part, can implement the process 300, to simplify discussion, the process 300 will be described in relation to the platform 150 of FIGS. 1-2.

In general, blocks 402 and 403 relate to determining a client authorization to which a seed input will relate. At block 402, the platform 150 determines one or more unopened bank accounts for the client authorization. At block 403, the platform 150 determines permissions in relation to the unopened bank account(s) determined at block 402.

In some embodiments, the unopened account(s) and the permission(s) can be indicated in advisor input provided by the registered investment advisor, for example, as described relative to the block 304 of FIG. 3. The permissions can include, for example, permissions to perform account transfers, move money, etc. In some embodiments, some or all of the permissions can be pre-established in an electronic form that is an LOA, for example. In addition, or alternatively, in some embodiments, some or all of the permissions can be specified in such an electronic form via checkboxes or other indications.

At block 404, the platform 150 prompts the client for approval to automatically generate the client authorization (e.g., a signed LOA), at a later time, in response to a later occurrence of an account-open event for the unopened bank account(s). For example, the computing system may present an “Approve” prompt on a user interface allowing the user to indicate approval and a “Decline” prompt on the user interface allowing the user to indicate refusal.

At decision block 406, the platform 150 determines whether the client has provided approval in response to the prompt at the block 404. If the platform 150 determines, at the decision block 406, that the client has indicated refusal via, for example, the “Decline” prompt, at block 408, the platform 150 may terminate the client onboarding application flow. After block 408, the process 400 ends. However, if the platform 150 determines, at the decision block 406, that the client has provided approval in response to the prompt at the block 404, the process 400 proceeds to block 410. At block 410, the platform 150 stores an indication of the approval, for example, in the database(s) 272. After block 410, the process 400 ends.

FIG. 5 illustrates an example process 500 for dynamically generating a client authorization based on a seed input and dynamic information, according to certain embodiments. For illustrative purposes, the process 500 is described relative to a client onboarding application flow involving a registered investment advisor and a client. In various embodiments, the process 500 can be, performed, for example, as part of the block 320 of FIG. 3. Although any number of systems, in whole or in part, can implement the process 300, to simplify discussion, the process 500 will be described in relation to the platform 150 of FIGS. 1-2.

At block 502, the platform 150 generates an authorization. The authorization can correspond, for example, to an earlier client approval as described relative to FIG. 4. In certain embodiments, generating the authorization includes generating a digital LOA form. For example, the authorization may include a digital LOA. The platform 150 can select the digital LOA (e.g., from database(s) 272).

At block 504, the platform 150 automatically populates one or more fields of the authorization with data. In general, the block 504 can include populating the authorization with dynamic information such as, for example, the dynamic information that is accessed as discussed relative to the block 318 of FIG. 3. The block 504 can further include populating the authorization with any other information requested by the authorization, such as account information, beneficiaries, any other provided as client input (e.g., as part of block 306 of FIG. 3), and so forth.

At block 506, the platform 150 inserts permissions into the authorization. The permissions can include certain allowed actions for the registered investment advisor. The permissions can correspond, for example, to the permissions determined at the block 403 of FIG. 4. In some embodiments, platform 150 can indicate the permissions in a digital LOA form, for example, via checkbox or other indication. In some embodiments, the permissions can be pre-specified in a digital LOA form, such that the block 506 can be omitted.

At block 508, the platform 150 causes the authorization to be digitally signed with a signature associated with the client, for example, pursuant to approval obtained during the process 400 of FIG. 4. The block 508 can involve, for example, populating a signature field of the authorization with the signature associated with the client. In some cases, the block 508 can include the platform 150 digitally signing the authorization with the signature. In some embodiments, the platform 150 can cause the authorization to be digitally signed via an API call to another component that inserts the signature. After block 508, the process 500 ends.

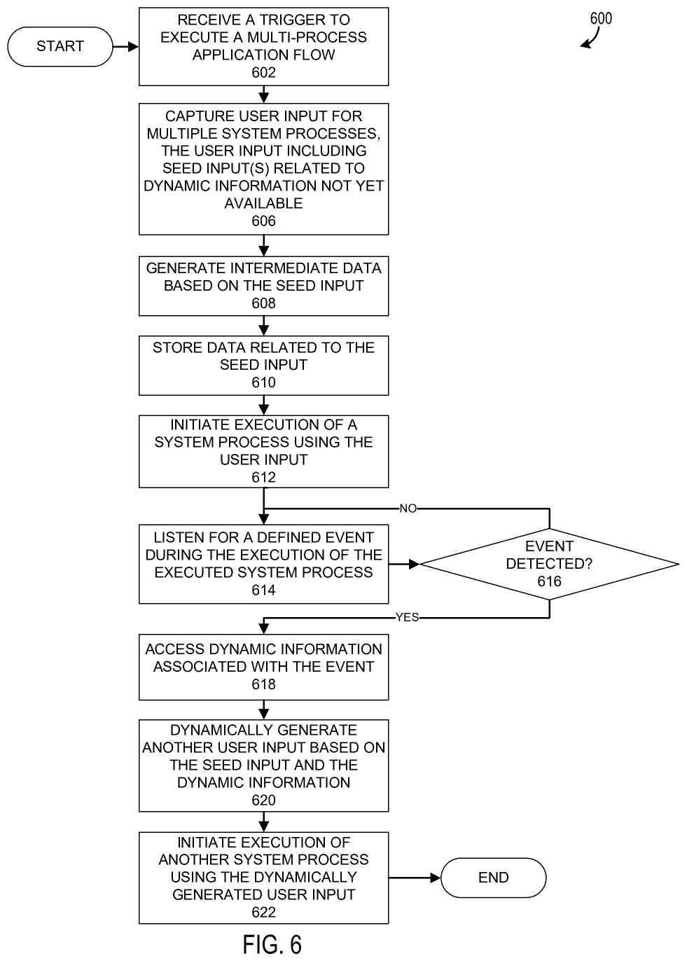

For illustrative purposes, FIGS. 3-5 above describe various examples of minimizing user touchpoints and application delays in an onboarding flow involving a registered investment advisor and a client. It should be appreciated, however, that the principles described herein are similarly applicable to other types of users and other types of application flows involving interdependent system processes and/or user inputs. For clarity, a more general context for the specific examples of FIGS. 3-5 will be described relative to FIG. 6.

FIG. 6 illustrates an example process 600 for minimizing user touchpoints and delays during application execution, according to certain embodiments. Although any number of systems, in whole or in part, can implement the process 600, to simplify discussion, the process 600 will be described in relation to the platform 150 of FIGS. 1-2.

At block 602, the platform 150 receives a trigger to execute a multi-process application flow for a user. The user can be, for example, a client as discussed relative to FIGS. 1-5. In an example, the trigger can be receipt of a command from a registered investment advisor as discussed relative to the block 302. In another example, the trigger can be the capture of input from another user, such as the input received from a registered investment advisor as discussed relative to the block 304 of FIG. 3. Other examples will be apparent to one skilled in the art after a detailed review of the present disclosure.

The multi-process application flow can correspond, for example, to all or a portion of the client onboarding application flow discussed relative to FIGS. 1-5. In general, the multi-process application flow includes different system processes that each operate based on different user input. More particularly, some system processes may operate based on user input that is dependent upon an event associated with another system process.

For example, as discussed relative to FIGS. 1-5, one system process may be an account-opening process for an account, while another system process may be a process that relies on a user authorization related to the account once it is open. According to this example, the account-opening process operates based one set of user input (e.g., account information, beneficiary information, etc.), while the other system process operates based other user input, specifically, a user authorization that refers to dynamic information associated with the account (e.g., an account number). According to this example, the dynamic information (e.g., an account number) becomes available upon the occurrence of an account-open event during the account-opening process, thus making the other user input dependent upon the account-open event.

At block 606, the platform 150 captures user input for multiple system processes. Continuing the example discussed relative to the block 602, the user input can include, for example, the set of user input operated on by the account-opening process. Further, the captured user input can include a seed input related to the other user input operated on by the other system process. In general, the user input, including the seed input, can be captured in any of the ways discussed relative to the block 306 of FIG. 3 and/or the process 400 of FIG. 4.

At block 608, the platform 150 generates intermediate data based on the seed input. The intermediate data can be generated, for example, as discussed relative to the block 308 of FIG. 3. In certain embodiments, the block 608 can be omitted, for example, in favor formatting and arranging data at the time of generating the other user input.

At block 610, the platform 150 stores data related to the seed input, for example, in the database(s) 272. For example, in some embodiments, the platform 150 can store the seed input, the intermediate data, if any, generated at the block 608, the client input, and/or other data.

At block 612, the platform 150 initiates execution of a system process using the user input. Continuing the example introduced above relative to the block 602, the system process can be, for example, the account-opening process that operates based on a set of user input (e.g., account information, beneficiary information, etc.). In general, the block 612 can include executing any of the functionality discussed relative to the block 312 of FIG. 3.

At block 614, the platform 150 listens for a defined event during the execution of the system process initiated at the block 612. Continuing the example introduced above relative to the block 602, the defined event can be, for example, an account-open event. In general, the block 614 can include executing any of the functionality discussed relative to the block 314 of FIG. 3. At decision block 616, if it is determined that the defined event has not been detected, the process 600 returns to the block 614, where the platform 150 continues to listen for the defined event. Otherwise, if it is determined, at decision block 616, that the defined event is detected, the process 600 proceeds to block 618.

At block 618, the platform 150 accesses dynamic information associated with the defined event. Continuing the example introduced above relative to the block 602, the dynamic information can include, for example, an account number, a date of account opening, an opening balance, and/or the like. In some cases, some or all of the dynamic information can be accessed from a data store and/or via an API call. In addition, alternatively, some or all of the dynamic information can be provided along with, for example, an alert or notification associated with the defined event. In general, the block 618 can include executing any of the functionality discussed relative to the block 318 of FIG. 3.

At block 620, the platform 150 dynamically generates other user input operated on by another system process. In certain embodiments, the other user input is generated without interaction with the user. For example, the platform 150 can automatically populate an electronic form and cause the electronic form to be digitally signed using a digital signature associated with the client. In general, the block 620 can include executing any of the functionality discussed relative to the block 320 of FIG. 3 and/or the process 500 of FIG. 5.

At block 622, the platform 150 initiates execution of the other system process using the user input dynamically generated at the block 620. In general, the block 622 can include executing any of the functionality discussed relative to the block 322 of FIG. 3. After block 622, the process 600 ends.

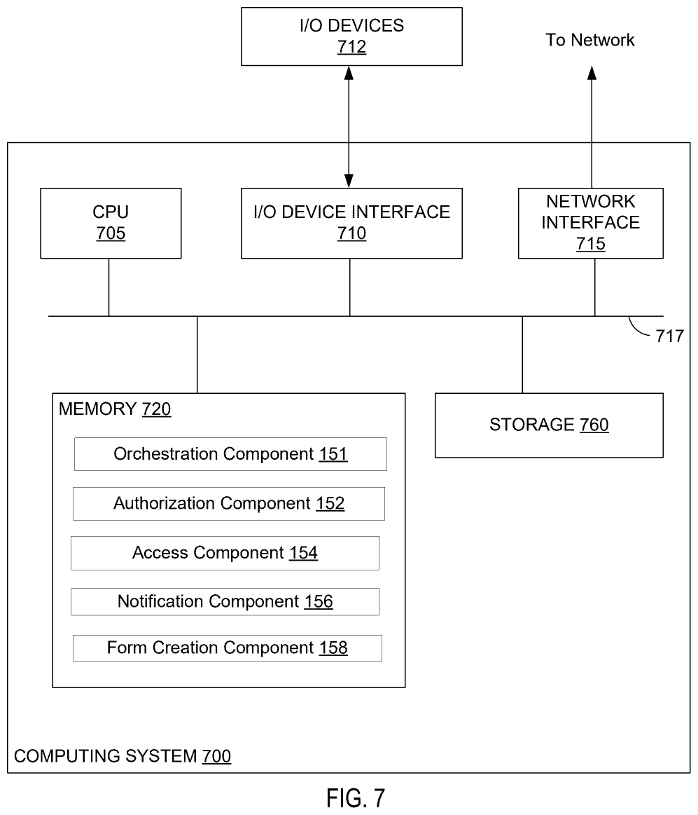

FIG. 7 illustrates an example computing system 700 configured to perform ophthalmic image registration, according to certain embodiments. As shown, the computing system 700 includes, without limitation, a central processing unit (CPU) 705, a network interface 715, a memory 720, and storage 760, each connected to a bus 717. The computing system 700 may also include an I/O device interface 710 connecting I/O devices 712 (e.g., keyboard, display and mouse devices) to the computing system 700. The computing system 700 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used.

The CPU 705 retrieves and executes programming instructions stored in the memory 720 as well as stored in the storage 760. The bus 717 is used to transmit programming instructions and application data between the CPU 705, I/O device interface 710, storage 760, network interface 715, and memory 720. Note, CPU 705 is included to be representative of a single CPU, multiple CPUs, a single CPU having multiple processing cores, and the like, and the memory 720 is generally included to be representative of a random access memory. The storage 760 may be a disk drive or flash storage device. Although shown as a single unit, the storage 760 may be a combination of fixed and/or removable storage devices, such as fixed disc drives, removable memory cards, optical storage, network attached storage (NAS), or a storage area-network (SAN). Illustratively, the memory 720 includes the orchestration component 151, the authorization component 152, the access component 154, the notification component 156, and the form creation component 158, which are discussed in greater detail above.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

The foregoing description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with the language of the claims.

Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.” The word “exemplary” is used herein to mean “serving as an example, instance, or illustration.” Any aspect described herein as “exemplary” is not necessarily to be construed as preferred or advantageous over other aspects.

What is claimed is:

1. A system for minimizing user touchpoints and delays during application execution, the system comprising:
a memory comprising executable instructions;
a processor in communication with the memory and configured to execute the instructions to:
receive a trigger to execute an application flow comprising a first system process and a second system process, wherein:
the first system process operates based on a first user input;
the second system process operates based on a second user input; and
the second user input is dependent upon an event associated with the first system process;
responsive to the trigger, capture, from a user, the first user input and a seed input related to the second user input;
initiate execution of the first system process using the first user input;
detect an occurrence of the event during the execution of the first system process; and
responsive to the detection, dynamically generate the second user input, without interaction with the user, based on a combination of the seed input and dynamic information associated with the detected occurrence of the event.

2. The system of claim 1, wherein the processor is further configured to execute the instructions to initiate execution of the second system process using the dynamically generated second user input.

3. The system of claim 1, wherein the seed input comprises a user approval to generate the second user input in response to the occurrence of the event.

4. The system of claim 3, wherein the second user input comprises a signed form from the user, the signed form from the user including at least some of the dynamic information.

5. The system of claim 3, wherein the dynamic generation of the second user input comprises:
automatically populating an electronic form with at least some of the dynamic information; and
causing the electronic form to be digitally signed using a digital signature associated with the user.

6. The system of claim 1, wherein the processor is further configured to:
generate intermediate data based on the seed input; and
store the intermediate data in a data store, wherein the dynamic generation of the second user input is further based on the intermediate data.

7. The system of claim 1, wherein the event comprises an opening of an account associated with the user, the dynamic information comprising information related to the opened account.

8. The system of claim 1, wherein the processor is further configured to listen for the event during the execution of the first system process.

9. The system of claim 8, wherein the processor is further configured to:
detect the event during the execution of the first system process; and
access the dynamic information responsive to the detection.

10. A computer-implemented method of minimizing user touchpoints and delays during application execution, the method comprising:
receiving a trigger to execute an application flow comprising a first system process and a second system process, wherein:
the first system process operates based on a first user input;
the second system process operates based on a second user input; and
the second user input is dependent upon an event associated with the first system process;
responsive to the trigger, capturing, from a user, the first user input and a seed input related to the second user input;
initiating execution of the first system process using the first user input;
detecting an occurrence of the event during the execution of the first system process; and
responsive to the detecting, dynamically generating the second user input, without interaction with the user, based on a combination of the seed input and dynamic information associated with the detected occurrence of the event.

11. The computer-implemented method of claim 10, further comprising initiating execution of the second system process using the dynamically generated second user input.

12. The computer-implemented method of claim 10, wherein the seed input comprises a user approval to generate the second user input in response to the occurrence of the event.

13. The computer-implemented method of claim 12, wherein the second user input comprises a signed form from the user, the signed form from the user including at least some of the dynamic information.

14. The computer-implemented method of claim 12, wherein the dynamically generating the second user input comprises:
automatically populating an electronic form with at least some of the dynamic information; and
causing the electronic form to be digitally signed using a digital signature associated with the user.

15. The computer-implemented method of claim 10, further comprising, responsive to the capturing:
generating intermediate data based on the seed input; and
storing the intermediate data in a data store, wherein the dynamic generation of the second user input is further based on the intermediate data.

16. The computer-implemented method of claim 10, wherein the event comprises an opening of an account associated with the user, the dynamic information comprising information related to the opened account.

17. The computer-implemented method of claim 10, further comprising listening for the event during the execution of the first system process.

18. The computer-implemented method of claim 17, further comprising:
detecting the event during the execution of the first system process; and
accessing the dynamic information responsive to the detecting.

19. A computer-program product comprising a non-transitory computer-usable medium having computer-readable program code embodied therein, the computer-readable program code adapted to be executed to implement a method comprising:
receiving a trigger to execute an application flow comprising a first system process and a second system process, wherein:
the first system process operates based on a first user input;
the second system process operates based on a second user input; and
the second user input is dependent upon an event associated with the first system process;
responsive to the trigger, capturing, from a user, the first user input and a seed input related to the second user input;
initiating execution of the first system process using the first user input;
detecting an occurrence of the event during the execution of the first system process; and
responsive to the detecting, dynamically generating the second user input, without interaction with the user, based on a combination of the seed input and dynamic information associated with the detected occurrence of the event.

20. The computer-program product of claim 19, the method further comprising initiating execution of the second system process using the dynamically generated second user input.
